(19) United States
(12) Patent Application Publication
(10) Pub. No.: US 2024/0266564 A1
(43) Pub. Date: Aug. 8, 2024

(54) FUEL CELL UNIT

(71) Applicant: TOYOTA JIDOSHA KABUSHIKI KAISHA, Toyota-shi (JP)

(72) Inventor: Kenji SATO, Kasugai-shi (JP)

(73) Assignee: TOYOTA JIDOSHA KABUSHIKI KAISHA, Toyota-shi (JP)

(21) Appl. No.: 18/501,398

(22) Filed: Nov. 3, 2023

(30) Foreign Application Priority Data
Feb. 3, 2023 (JP) 2023-015140

(51) Int. Cl. H01M 8/04082; H01M 8/04746; H01M 8/2484; H01M 8/249

(52) U.S. Cl. CPC H01M 8/04201; H01M 8/04753; H01M 8/04783; H01M 8/2484; H01M 8/249

(57) ABSTRACT

The fuel cell unit includes an air compressor, a first fuel cell stack, a second fuel cell stack, a first supply pipe, a first discharge pipe, a second supply pipe, and a second discharge pipe. there is The first supply pipe has a first main pipe connected to a first location of the first fuel cell stack and a first bypass pipe connected to a second location of the first fuel cell stack. The second supply pipe has a second main pipe connected to a third location of the second fuel cell stack and a second bypass pipe connected to a fourth location of the second fuel cell stack. A flow regulating valve is provided in each of the first bypass pipe and the second bypass pipe.

### CROSS-REFERENCE TO RELATED APPLICATION

This application claims priority to Japanese Patent Application No. 2023-015140 filed on Feb. 3, 2023 incorporated herein by reference in its entirety.

### BACKGROUND

### 1. Technical Field

The technology disclosed in the present specification relates to a fuel cell unit.

### 2. Description of Related Art

Japanese Unexamined Patent Application Publication No. 2022-45809 (JP 2022-45809 A) discloses a fuel cell unit including an air compressor, a first fuel cell stack, a second fuel cell stack, a first supply pipe that supplies air from the air compressor to the first fuel cell stack, a first discharge pipe that recovers post-reaction air discharged from the first fuel cell stack, a second supply pipe that supplies air from the air compressor to the second fuel cell stack, and a second discharge pipe that recovers post-reaction air discharged from the second fuel cell stack.

### SUMMARY

In a configuration in which air is supplied to two fuel cell stacks from one air compressor, as in the fuel cell unit disclosed in JP 2022-45809 A, it is desirable to make an air supply amount per cell or an air supply pressure between the first fuel cell stack and the second fuel cell stack to be equal, in order to improve performance of the fuel cell stacks.

The present specification provides a technology that is capable of making the air supply amount per cell or the air supply pressure to be equal between the first fuel cell stack and the second fuel cell stack.

A first aspect of the present technology provides a fuel cell unit. The fuel cell unit may include
an air compressor,
a first fuel cell stack,
a second fuel cell stack,
a first supply pipe that supplies air from the air compressor to the first fuel cell stack,
a first discharge pipe that recovers post-reaction air discharged from the first fuel cell stack,
a second supply pipe that supplies air from the air compressor to the second fuel cell stack, and
a second discharge pipe that recovers post-reaction air discharged from the second fuel cell stack.

The first supply pipe may include a first main pipe connected to a first position of the first fuel cell stack and a first bypass pipe connected to a second position of the first fuel cell stack.

The second supply pipe may include a second main pipe connected to a third position of the second fuel cell stack and a second bypass pipe connected to a fourth position of the second fuel cell stack.

A flow regulating valve may be provided in each of the first bypass pipe and the second bypass pipe.

According to the above configuration, adjusting an opening degree of the flow regulating valves provided to the first bypass pipe and the second bypass pipe enables pressure loss of the first fuel cell stack and pressure loss of the second fuel cell stack to be adjusted. By adjusting the pressure loss of the first fuel cell stack and the pressure loss of the second fuel cell stack, “air supply amount per cell” or “air supply pressure” can be made to be equal between the first fuel cell stack and the second fuel cell stack.

According to a second aspect, in the above first aspect,
each of the first fuel cell stack and the second fuel cell stack may include an air supply manifold through which pre-reaction air flows along a stacking direction of fuel-cell cells.

The first position may be located at, in the stacking direction, one end of the air supply manifold of the first fuel cell stack, and
the second position may be located at, in the stacking direction, another end of the air supply manifold of the first fuel cell stack.

The third position may be located at, in the stacking direction, one end of the air supply manifold of the second fuel cell stack, and
The fourth position may be located at, in the stacking direction, another end of the air supply manifold of the second fuel cell stack.

Connecting the first main pipe and the first bypass pipe to the end portions on both sides in the stacking direction facilitates adjustment of the pressure loss of the first fuel cell stack. Similarly, connecting the second main pipe and the second bypass pipe to the end portions on both sides in the stacking direction facilitates adjustment of the pressure loss of the second fuel cell stack. Accordingly, by adjusting the opening degree of the flow regulating valves, the “air supply amount per cell” or the “air supply pressure” can easily be made to be equal between the first fuel cell stack and the second fuel cell stack.

A third aspect of the present technology provides a fuel cell unit.

The fuel cell unit may include
an air compressor,
a first fuel cell stack,
a second fuel cell stack,
a first supply pipe that supplies air from the air compressor to the first fuel cell stack,
a first discharge pipe that recovers post-reaction air discharged from the first fuel cell stack,
a second supply pipe that supplies air from the air compressor to the second fuel cell stack, and
a second discharge pipe that recovers post-reaction air discharged from the second fuel cell stack.

The first discharge pipe may include a first main pipe connected to a fifth position of the first fuel cell stack and a first bypass pipe connected to a sixth position of the first fuel cell stack.

The second discharge pipe may include a second main pipe connected to a seventh position of the second fuel cell stack and a second bypass pipe connected to an eighth position of the second fuel cell stack.

A flow regulating valve may be provided in each of the first bypass pipe and the second bypass pipe.

According to the above configuration, adjusting the opening degree of the flow regulating valves provided to the first bypass pipe and the second bypass pipe enables the pressure loss of the first fuel cell stack and the pressure loss of the second fuel cell stack to be adjusted. By adjusting the pressure loss of the first fuel cell stack and the pressure loss of the second fuel cell stack, “air supply amount per cell” or “air supply pressure” can be made to be equal between the first fuel cell stack and the second fuel cell stack.

According to a fourth aspect, in any one of the first to third aspects, a control device that controls the flow regulating valve may be further provided.

The control device may control the flow regulating valve such that “air supply amount per cell” is equal between the first fuel cell stack and the second fuel cell stack.

Within each fuel cell stack, water is produced by the reaction of hydrogen and oxygen. In the fuel cell unit, an amount of water present in each fuel cell stack is controlled by adjusting an amount of air supplied to each fuel cell stack. According to the above configuration, making the “air supply amount per cell” to be equal between the first fuel cell stack and the second fuel cell stack enables the amount of air supplied to each fuel cell stack to be adjusted to an amount of air in accordance with the number of fuel-cell cells that each fuel cell stack has. Accordingly, the amount of water present in each fuel cell stack can be adjusted appropriately.

According to a fifth aspect, in any one of the first to third aspects, the fuel cell unit may further include a control device that controls the flow regulating valve. The control device may control the flow regulating valve such that “air supply pressure” is equal between the first fuel cell stack and the second fuel cell stack.

Making the “air supply pressure” to be equal between the first fuel cell stack and the second fuel cell stack enables pressure placed on the fuel-cell cells within each fuel cell stack to be made to be equal. Accordingly, a degree of deterioration of each fuel cell stack can be made to be the same, and durability of the fuel cell unit can be improved.

Details of the technology disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a fuel cell unit according to a first embodiment;

FIG. 2 is a flowchart of valve control processing executed by a control device;

FIG. 3 is a flowchart of valve control processing executed by the control device according to the second embodiment;

FIG. 4 is a diagram schematically showing the configuration of a fuel cell unit according to a third embodiment;

FIG. 5 is a diagram schematically showing the configuration of a fuel cell unit according to a fourth embodiment; and

FIG. 6 is a flowchart of valve control processing executed by a control device according to a fourth embodiment;

### DETAILED DESCRIPTION OF EMBODIMENTS

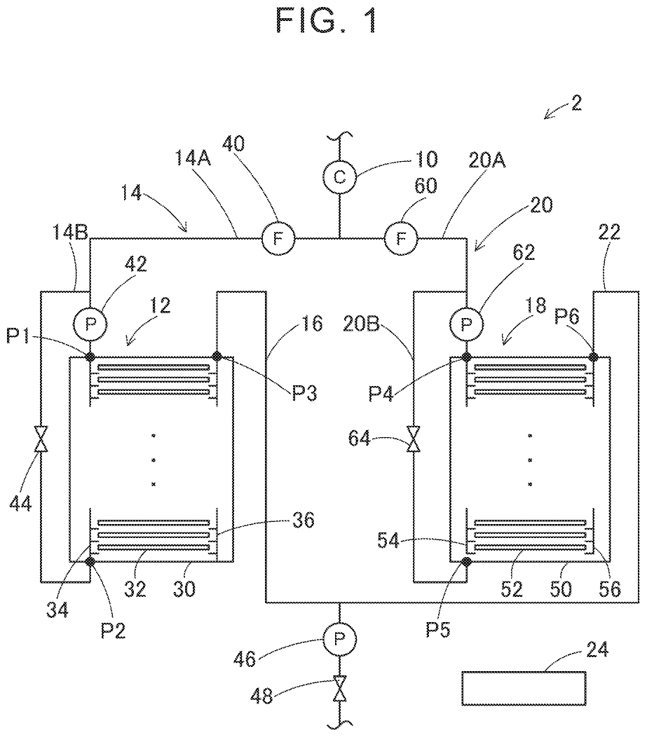

As shown in FIG. 1, the fuel cell unit 2 includes an air compressor 10, a first fuel cell stack 12, a first supply pipe 14, a first discharge pipe 16, a second fuel cell stack 18, and a second supply pipe 20, a second discharge pipe 22, and a control device 24 are provided. The fuel cell unit 2 is mounted, for example, on a fuel cell electric vehicle.

The air compressor 10 supplies air containing oxygen to the first fuel cell stack 12 and the second fuel cell stack 18. The first fuel cell stack 12 and the second fuel cell stack 18 generate electric power by reacting oxygen contained in air supplied from the air compressor 10 with hydrogen supplied from a fuel tank (not shown).

The first fuel cell stack 12 includes a case 30, a plurality of fuel-cell cells 32, an air supply manifold 34 through which pre-reaction air flows, and an air discharge manifold 36 through which post-reaction air flows. The fuel-cell cell 32 is, for example, a polymer electrolyte fuel cell. A plurality of fuel-cell cells 32 are accommodated within the case 30. The plurality of fuel-cell cells 32 is stacked in the stacking direction (vertical direction in FIG. 1). The air supply manifold 34 extends in the stacking direction inside the case 30. The air supply manifold 34 is connected to an upper end position P1 of the case 30 and a lower end position P2 of the case 30. The air discharge manifold 36 extends in the stacking direction inside the case 30. The air discharge manifold 36 is connected to the upper end of the case 30 at a position P3. Positions P1 and P2 are positioned on the left end side of the case 30, and position P3 is positioned on the right end side, in a direction perpendicular to the stacking direction (horizontal direction in FIG. 1).

A first supply pipe 14 supplies air from the air compressor 10 to the first fuel cell stack 12. The first supply pipe 14 includes a first main pipe 14A and a first bypass pipe 14B. One end of the first main pipe 14A is connected to the air compressor 10. The other end of the first main pipe 14A is connected to the air supply manifold 34 of the first fuel cell stack 12 at position P1. A flow rate sensor 40 and a pressure sensor 42 are provided in the first main pipe 14A. The flow rate sensor 40 is provided upstream of the pressure sensor 42. One end of the first bypass pipe 14B is connected in the middle of the first main pipe 14A. The other end of the first bypass pipe 14B is connected to the air supply manifold 34 of the first fuel cell stack 12 at position P2. One end of the first bypass pipe 14B is connected to the first main pipe 14A at a position between the flow rate sensor 40 and the pressure sensor 42. A flow regulating valve 44 is provided in the first bypass pipe 14B.

The first discharge pipe 16 recovers post-reaction air discharged from the first fuel cell stack 12. One end of the first discharge pipe 16 is connected to the air discharge manifold 36 of the first fuel cell stack 12 at position P3. The other end of the first discharge pipe 16 is connected to a discharge point (not shown) for post-reaction air and water. A pressure sensor 46 and a pressure regulating valve 48 are provided in the first discharge pipe 16. The pressure sensor 46 is provided upstream of the pressure regulating valve 48.

The second fuel cell stack 18 includes a case 50, multiple fuel-cell cells 52, an air supply manifold 54 and an air discharge manifold 56. The case 50, the plurality of fuel-cell cells 52, the air supply manifold 54, and the air discharge manifold 56 have the same configurations as the case 30, the plurality of fuel-cell cells 32, the air supply manifold 34, and the air discharge manifold 36, respectively. there is In this embodiment, the number of the plurality of fuel-cell cells 32 in the first fuel cell stack 12 (hereinafter referred to as “the number of first cells”) and the number of fuel-cell cells in the second fuel cell stack 18 52 (hereinafter referred to as “second cell number”). Positions P4, P5 and P6 of case 50 correspond to positions P1, P2 and P3 of case 30, respectively.

A second supply pipe 20 supplies air from the air compressor 10 to the second fuel cell stack 18. The second supply pipe 20 includes a second main pipe 20A and a second bypass pipe 20B. One end of the second main pipe 20A is connected to the air compressor 10. The other end of the second main pipe 20A is connected to the air supply manifold 54 of the second fuel cell stack 18 at position P4. A part of the second main pipe 20A is shared with the first main pipe 14A. A flow rate sensor 60 and a pressure sensor 62 are provided in the second main pipe 20A. One end of the second bypass pipe 20B is connected in the middle of the second main pipe 20A. The other end of the second bypass pipe 20B is connected to the air supply manifold 54 of the second fuel cell stack 18 at position P5. One end of the second bypass pipe 20B is connected to the second main pipe 20A at a position between the flow rate sensor 60 and the pressure sensor 62. A flow regulating valve 64 is provided in the second bypass pipe 20B. The flow rate sensors 40, 60 and the pressure sensors 42, 62 are provided downstream of the shared portion of the first main pipe 14A and the second main pipe 20A.

The second discharge pipe 22 recovers post-reaction air exhausted from the second fuel cell stack 18. One end of the second discharge pipe 22 is connected to the air discharge manifold 56 of the second fuel cell stack 18 at position P6. The other end of the second discharge pipe 22 is connected to the discharge point. A part of the second discharge pipe 22 is shared with the first discharge pipe 16. A pressure sensor 46 and a pressure regulating valve 48 are provided in a shared portion of the first discharge pipe 16 and the second discharge pipe 22.

The control device 24 is configured using a computer having a CPU, ROM, and RAM. A control device 24 controls the operation of flow regulating valves 44, 64 and flow regulating valve 48.

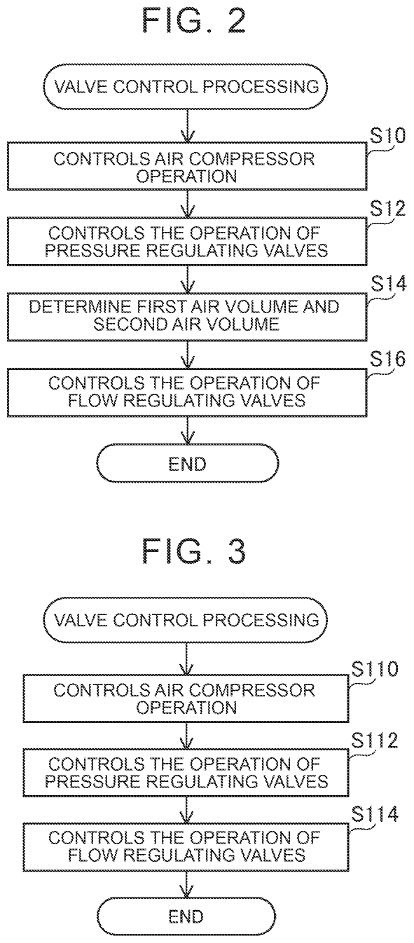

### Valve Control Processing; FIG. 2

The valve control process executed by the control device 24 will be described with reference to FIG. 2.

In S10, the control device 24 controls the operation of the air compressor 10 so that the amount of air supplied from the air compressor 10 becomes the target air amount. As a result, air is supplied from the air compressor 10 to the first fuel cell stack 12 and the second fuel cell stack 18.

In S12, the control device 24 controls the operation of the pressure regulating valve 48 so that the outlet pressure detected by the pressure sensor 46 becomes the first predetermined pressure.

In S14, the control device 24 specifies the first air amount to be supplied to the first fuel cell stack 12 and the second air amount to be supplied to the second fuel cell stack 18. First, the control device 24 specifies the total number of cells, which is the sum of the number of first cells and the number of second cells. The control device 24 then determines the “air supply amount per cell” by dividing the amount of air supplied from air compressor 10 by the total number of cells. Then, the control device 24 multiplies the first cell number by the “air supply amount per cell” to specify the first air amount, and multiplies the second cell number by the “air supply amount per cell”. By doing so, the second air amount is specified. In addition, in the present embodiment, since the number of the first cells and the number of the second cells are the same, the first air amount and the second air amount are the same.

In S16, the control device 24 sets the air amount detected by the flow rate sensor 40 on the first main pipe 14A to be the first air amount, and sets the air amount detected by the flow rate sensor 60 on the second main pipe 20A to The operation of the flow regulating valves 44 and 64 is controlled so as to obtain the second air amount. When S16 ends, the control device 24 ends the process of FIG. 2. In the initial state, the flow regulating valves 44 and 64 are closed. The control device 24 executes the process of FIG. 2 each time the target air amount changes.

### Effect of this Embodiment

The fuel cell unit 2 includes an air compressor 10, a first fuel cell stack 12, a second fuel cell stack 18, a first supply pipe 14, a first discharge pipe 16, a second supply pipe 20, a second and a second discharge pipe 22. The first supply pipe 14 includes a first main pipe 14A connected to a position P1 (an example of a “first position”) of the first fuel cell stack 12 and a first bypass pipe 14B connected to a position P2 (an example of a “second position”) of the first fuel cell stack 12. The second supply pipe 20 includes a second main pipe 20A connected to a position P4 of the second fuel cell stack 18 (an example of a “third position”) and a second bypass pipe 20B connected to a position P5 (an example of a “fourth position”) of the second fuel cell stack 18. Flow regulating valves 44 and 64 are provided in the first bypass pipe 14B and the second bypass pipe 20B, respectively.

According to the above configuration, by adjusting the opening degree of the flow regulating valves 44, 64 provided in the first bypass pipe 14B and the second bypass pipe 20B, the pressure loss in the first fuel cell stack 12 and the pressure loss in the second fuel cell stack 18 can be adjusted. By adjusting the pressure loss of the first fuel cell stack 12 and the pressure loss of the second fuel cell stack 18, the “air supply amount per cell” between the first fuel cell stack 12 and the second fuel cell stack 18 can be equal.

It is conceivable that, when the number of first cells and the number of second cells are the same, even if the flow regulating valves 44 and 64 are not provided, the “air per cell stack” between the first fuel cell stack 12 and the second fuel cell stack 18 will be equal. However, even if the first cell number and the second cell number are the same, the pressure loss of the first fuel cell stack 12 differs from that of the second fuel cell stack 18 due to manufacturing tolerances and the like. In this case, the amount of air supplied to the first fuel cell stack 12 and the amount of air supplied to the second fuel cell stack 18 are different. Then, the “air supply amount per cell” will differ between the first fuel cell stack 12 and the second fuel cell stack 18. Therefore, in this embodiment, the pressure loss in the first fuel cell stack 12 and the pressure loss in the second fuel cell stack 18 are adjusted by adjusting the opening degrees of the flow regulating valves 44 and 64. The “air supply amount per cell” is made equal between the first fuel cell stack 12 and the second fuel cell stack 18.

Each of the first fuel cell stack 12 and the second fuel cell stack 18 has air supply manifolds 34 and 54 through which pre-reaction air flows along the stacking direction of the fuel-cell cells 32 and 52. The position P1 is located at the upper end of the first fuel cell stack 12 (an example of “one end in the stacking direction of the air supply manifold”). The position P2 is located at the lower end of the first fuel cell stack 12 (an example of “the other end in the stacking direction of the air supply manifold”). The position P4 is located at the upper end of the second fuel cell stack 18 (an example of “one end in the stacking direction of the air supply manifold”). The position P5 is located at the lower end of the second fuel cell stack 18 (an example of “the other end in the stacking direction of the air supply manifold”).

According to the above configuration, by adjusting the opening degrees of the flow regulating valves 44 and 64, the “air supply amount per cell” can be easily equalized between the first fuel cell stack 12 and the second fuel cell stack 18.

Moreover, the fuel cell unit 2 further includes a control device 24 that controls the flow regulating valves 44 and 64. The control device 24 controls the flow regulating valves 44 and 64 so that the “air supply amount per cell” is equal between the first fuel cell stack 12 and the second fuel cell stack 18.

According to the above configuration, by equalizing the “air supply amount per cell” between the first fuel cell stack 12 and the second fuel cell stack 18, the amount of air supplied to each fuel cell stack 12, 18 is can be the amount of air according to the number of fuel-cell cells 32, 52 that each fuel cell stack 12, 18 has. Therefore, the amount of water present in each fuel cell stack 12, 18 can be adjusted appropriately.

### Second Embodiment

The fuel cell unit 2 of the second embodiment will be described with reference to FIG. 3. The fuel cell unit 2 of the second embodiment has the same configuration as the fuel cell unit 2 of the first embodiment. In this embodiment, the control device 24 executes the process of FIG. 3 instead of the process of FIGS. 2.

S110 and S112 are the same as S10 and S12 in FIG. 2, respectively.

In S114, the control device 24 controls the operation of the flow regulating valve 44, 64, so that the “air supply pressure” detected by the pressure sensor 42 on the first main pipe 14A and the “air supply pressure” detected by the pressure sensor 62 on the second main pipe 20A are the second predetermined pressure. That is, the control device 24 controls the flow regulating valves 44, 64 so that the “air supply pressure” of the air flowing through the first supply pipe 14 and the “air supply pressure” of the air flowing through the second supply pipe 20 are the same. When S114 ends, the control device 24 ends the processing of FIG. 3. The control device 24 executes the process of FIG. 3 each time the predetermined air amount changes.

According to the above configuration, by adjusting the opening degrees of the flow regulating valves 44 and 64 provided in the first bypass pipe 14B and the second bypass pipe 20B, the first fuel cell stack 12 and the second fuel cell stack 18 can equalize the “air supply pressure” between

Also, by equalizing the “air supply pressure” between the first fuel cell stack 12 and the second fuel cell stack 18, the pressure applied to the fuel-cell cells 32, 52 in each fuel cell stack 12, 18 can be equalized. Therefore, the degree of deterioration of the fuel cell stacks 12 and 18 can be made the same, and the durability of the fuel cell unit 2 can be improved.

### Third Embodiment

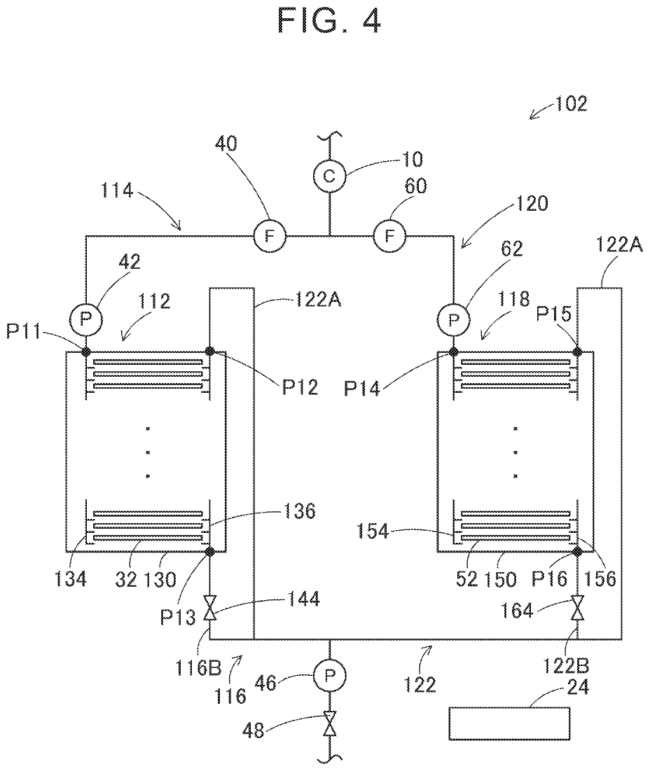

A fuel cell unit 102 of the third embodiment will be described with reference to FIG. 4. In addition, the same sign is subjected about the structure which is common between Examples, and the description is abbreviated.

The fuel cell unit 102 includes an air compressor 10, a first fuel cell stack 112, a first supply pipe 114, a first discharge pipe 116, a second fuel cell stack 118, a second supply pipe 120, a second discharge pipe 122 and a control device 24 are provided.

The first fuel cell stack 112 includes a case 130, multiple fuel-cell cells 32, an air supply manifold 134 and an air discharge manifold 136. The air supply manifold 134 extends in the stacking direction inside the case 130. The air supply manifold 134 is connected to the upper end position P11 of the case 130. The air discharge manifold 136 extends in the stacking direction inside the case 130. The air discharge manifold 136 is connected to the upper end position P12 of the case 130 and the lower end position P13 of the case 130. Position P11 is located on the left end side of case 130, and positions P12 and P13 are located on the right end side in the direction perpendicular to the stacking direction (horizontal direction in FIG. 4).

One end of the first supply pipe 114 is connected to the air compressor 10. The other end of the first supply pipe 114 is connected to the air supply manifold 134 of the first fuel cell stack 112 at position P11. A flow rate sensor 40 and a pressure sensor 42 are provided in the first supply pipe 114.

The first discharge pipe 116 includes a first main pipe 116A and a first bypass pipe 116B. One end of first main pipe 116A is connected to air discharge manifold 136 of first fuel cell stack 112 at position P12. The other end of the first main pipe 116A is connected to the discharge point. A pressure sensor 46 and a pressure regulating valve 48 are provided in the first main pipe 116A. One end of the first bypass pipe 116B is connected to the air discharge manifold 136 of the first fuel cell stack 112 at position P13. The other end of the first bypass pipe 116B is connected to the middle of the first main pipe 116A. The other end of the first bypass pipe 116B is connected to the first main pipe 116A upstream of the pressure sensor 46. A flow regulating valve 144 is provided in the first bypass pipe 116B.

The second fuel cell stack 118 includes a case 150, multiple fuel-cell cells 52, an air supply manifold 154 and an air discharge manifold 156. Case 150, air supply manifold 154, and air discharge manifold 156 have the same configurations as case 130, air supply manifold 134, and air discharge manifold 136, respectively. Positions P14, P15 and P16 of case 150 correspond to positions P11, P12 and P13 of case 130, respectively. The number of first cells and the number of second cells are the same.

One end of the second supply pipe 120 is connected to the air compressor 10. The other end of the second supply pipe 120 is connected to the air supply manifold 154 of the second fuel cell stack 118 at position P14. A portion of the second supply pipe 120 is shared with the first supply pipe 114. A flow rate sensor 60 and a pressure sensor 62 are provided in the second supply pipe 120. The flow rate sensors 40, 60 and the pressure sensors 42, 62 are provided downstream of the shared portion of the first supply pipe 114 and the second supply pipe 120.

The second discharge pipe 122 includes a second main pipe 122A and a second bypass pipe 122B. One end of the second main pipe 122A is connected to the air discharge manifold 156 of the second fuel cell stack 118 at position P15. The other end of the second main pipe 122A is connected to the discharge point. A part of the second main pipe 122A is shared with the first main pipe 116A. The pressure sensor 46 and the pressure regulating valve 48 are provided in a shared portion of the first main pipe 116A and the second main pipe 122A. One end of the second bypass pipe 122B is connected to the air discharge manifold 156 of the second fuel cell stack 118 at position P16. The other end of the second bypass pipe 122B is connected to the middle of the second main pipe 122A. The other end of the second bypass pipe 122B is connected to the second main pipe 122A upstream of the shared portion of the first main pipe 116A and the second main pipe 122A. A flow regulating valve 164 is provided in the second bypass pipe 122B.

The control device 24 is configured to execute the valve control process of FIG. 2 or the valve control process of FIG. 3.

### Effect of this Embodiment

The fuel cell unit 102 includes an air compressor 10, a first fuel cell stack 112, a second fuel cell stack 118, a first supply pipe 114, a first discharge pipe 116, a second supply pipe 120, a second discharge pipe 122. The first discharge pipe 116 includes a first main pipe 116A connected to a position P12 of the first fuel cell stack 112 (an example of a “fifth position”) and a first bypass pipe 116B connected to a position P13 of the first fuel cell stack 112 (an example of a “sixth position”). The second discharge pipe 122 includes a second main pipe 122A connected to a position P15 of the second fuel cell stack 118 (an example of a “seventh position”) and a second bypass pipe 122B connected to a position P16 of the second fuel cell stack 118 (an example of an “eighth position”). Flow regulating valves 144 and 164 are provided in the first bypass pipe 116B and the second bypass pipe 122B, respectively.

According to the above configuration, adjusting the opening degree of the flow regulating valves 144, 164 provided to the first bypass pipe 116B and the second bypass pipe 122B enables the pressure loss of the first fuel cell stack 112 and the pressure loss of the second fuel cell stack 118 to be adjusted. By adjusting the pressure loss of the first fuel cell stack 112 and the pressure loss of the second fuel cell stack 118, the “air supply amount per cell” or “air supply pressure” can be equal between the first fuel cell stack 112 and the second fuel cell stack 118 is adjusted.

### Fourth Embodiment

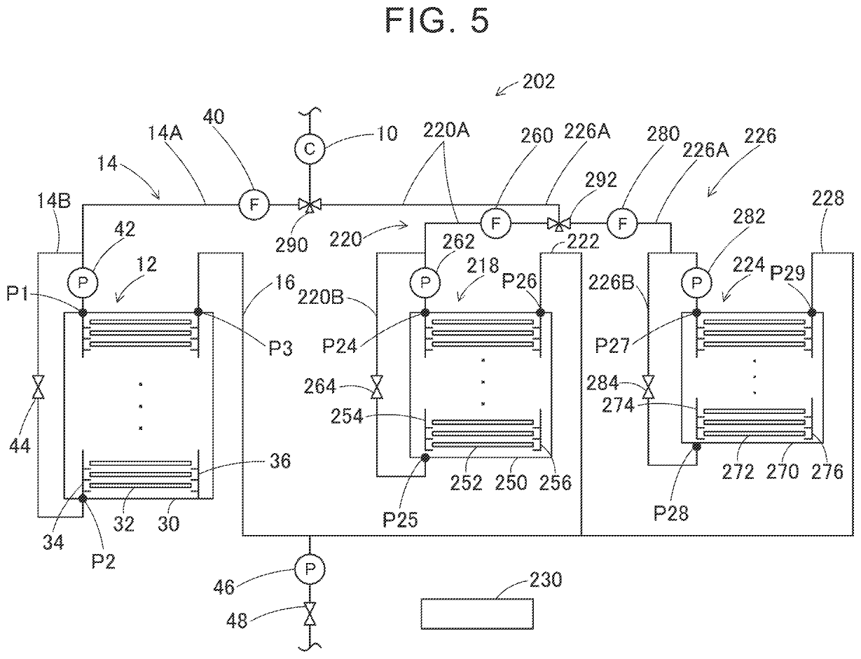

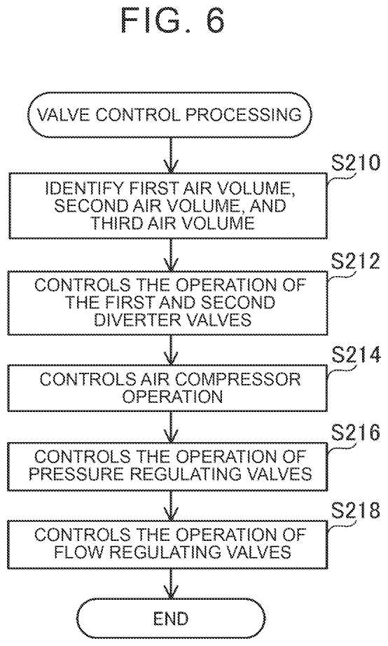

A fuel cell unit 202 of a fourth embodiment will be described with reference to FIGS. 5 and 6.

As shown in FIG. 5, the fuel cell unit 202 includes an air compressor 10, a first fuel cell stack 12, a first supply pipe 14, a first discharge pipe 16, a second fuel cell stack 218, and a second supply pipe 220, a second discharge pipe 222, a third fuel cell stack 224, a third supply pipe 226, a third discharge pipe 228 and a control device 230 are provided.

The second fuel cell stack 218 of this embodiment has a configuration similar to the second fuel cell stack 18 of the first embodiment with the exception that the number of the fuel-cell cells 252 differs from the number of the fuel-cell cells 52 of the first embodiment. In addition, the second fuel cell stack 218 of this embodiment has the same configuration as the second fuel cell stack 18 of the first embodiment with the except that the case 250, the air supply manifold 254, and the air discharge manifold 256 have shapes corresponding to the number of the fuel-cell cells 252. Positions P24, P25 and P26 respectively correspond to positions P4, P5 and P6 of the second fuel cell stack 18 of the first embodiment. Note that in this embodiment, the second number of cells is half the first number of cells.

The second supply pipe 220 includes a second main pipe 220A and a second bypass pipe 220B. The second main pipe 220A and the second bypass pipe 220B have configurations corresponding to the second main pipe 20A and the second bypass pipe 20B of the first embodiment, respectively. A flow rate sensor 260 and a pressure sensor 262 are provided in the second main pipe 220A. A flow regulating valve 264 is provided in the second bypass pipe 220B.

The second discharge pipe 222 has the same configuration as the second discharge pipe 22 of the first embodiment.

The third fuel cell stack 224 has the same configuration as the second fuel cell stack 218 except that the number of fuel-cell cells 272 differs from the number of fuel-cell cells 252. The third fuel cell stack 224 has the same configuration as the second fuel cell stack 218 with the exception that the case 270, air supply manifold 274, and air discharge manifold 276 have shapes corresponding to the number of fuel-cell cells 272. Positions P27, P28 and P29 correspond to positions P24, P25 and P26 of the second fuel cell stack 218, respectively. The number of fuel-cell cells 272 (hereinafter referred to as “third cell number”) is half the second cell number.

The third supply pipe 226 includes a third main pipe 226A and a third bypass pipe 226B. The third main pipe 226A and the third bypass pipe 226B have configurations corresponding to the second main pipe 220A and the second bypass pipe 220B, respectively. Part of the third main pipe 226A is shared with the first main pipe 14A and the second main pipe 220A. A flow rate sensor 280 and a pressure sensor 282 are provided in the third main pipe 226A. A flow regulating valve 284 is provided in the third bypass pipe 226B.

The third discharge pipe 228 has a configuration corresponding to that of the second discharge pipe 222.

The flow rate sensor 40 and the pressure sensor 42 are provided in the first main pipe 14A downstream of the shared portion of the first main pipe 14A, the second main pipe 220A, and the third main pipe 226A. The flow rate sensor 260 and the pressure sensor 262 are provided in the second main pipe 220A on the downstream side of the shared portion of the second main pipe 220A and the third main pipe 226A. The flow rate sensor 280 and the pressure sensor 282 are provided in the third main pipe 226A on the downstream side of the shared portion of the second main pipe 220A and the third main pipe 226A. The pressure sensor 46 and the pressure regulating valve 48 are provided in common portions of the first discharge pipe 16, the second discharge pipe 222 and the third discharge pipe 228.

The fuel cell unit 202 further comprises a first flow dividing valve 290 and a second flow dividing valve 292. The first flow dividing valve 290 is located at a location where it branches into the first main pipe 14A, the second main pipe 220A and the third main pipe 226A. It is provided at the downstream end of the shared portion of the first main pipe 14A, the second main pipe 220A, and the third main pipe 226A. The first flow dividing valve 290 adjusts the amount of air flowing into the first main pipe 14A and the amount of air flowing into the second main pipe 220A and the third main pipe 226A. The second flow dividing valve 292 is located at the point where the second main pipe 220A and the third main pipe 226A branch off, that is, the downstream end of the shared portion of the second main pipe 220A and the third main pipe 226A. The second flow dividing valve 292 adjusts the amount of air flowing to the second main pipe 220A side and the amount of air flowing to the third main pipe 226A side.

### Valve Control Processing; FIG. 6

The valve control process executed by control device 230 will be described with reference to FIG. 6.

In S210, the control device 230 determines the first air amount to be supplied to the first fuel cell stack 12, the second air amount to be supplied to the second fuel cell stack 18, and the third air amount to be supplied to the third fuel cell stack 224. First, the control device 230 specifies the total number of cells, which is the sum of the number of first cells, the number of second cells, and the number of third cells. Next, the control device 230 determines the “air supply amount per cell” by dividing the air amount supplied from the air compressor 10 by the total number of cells. Then, the control device 230 multiplies the first cell number by the “air supply amount per cell” to specify the first air amount, and multiplies the second cell number by the “air supply amount per cell” to specify the second air amount. Then, the third air amount is specified by multiplying the number of the third cells by the “air supply amount per cell”.

In S212, the control device 230 controls the operation of the first flow dividing valve 290 and the second flow dividing valve 292 using the first air amount, the second air amount, and the third air amount specified in S112. The control device 230 allows the air of the first air volume to flow to the first main pipe 14A side, and the air volume of the sum of the second air volume and the third air volume to flow into the second main pipe 220A and the third main pipe 226A. The opening degree of the first flow dividing valve 290 is adjusted so that the water flows to the side. Further, the control device 230 adjusts the opening degree of the second flow dividing valve 292 so that the second air volume flows to the second main pipe 220A side and the third air volume flows to the third main pipe 226A side. The opening degree of the first flow dividing valve 290 and the opening degree of the second flow dividing valve 292 may be set in advance.

S214 is the same as S10 in FIG. 2. Air is thereby supplied from the air compressor 10 to the first fuel cell stack 12, the second fuel cell stack 218, and the third fuel cell stack 224. S216 is the same as S12 in FIG. 2.

In S218, the control device 230 sets the air amount detected by the flow rate sensor 40 on the first main pipe 14A to be the first air amount, and the air amount detected by the flow rate sensor 260 on the second main pipe 220A to be the second air amount. The operation of the flow regulating valves 44, 264, 284 is controlled so that the amount of air detected by the flow rate sensor 280 on the third main pipe 226A becomes the third air amount. When S118 ends, the control device 230 ends the processing of FIG. 6. Control device 230 executes the process of FIG. 6 each time the target air amount changes.

According to the above configuration, even if the number of fuel-cell cells in each fuel cell stack 12, 18, 224 is different, the pressure loss of each fuel cell stack 12, 18, 224 can be adjusted. By adjusting the pressure loss of each fuel cell stack 12, 18, 224, the “air supply amount per cell” among the first fuel cell stack 12, the second fuel cell stack 18, and the third fuel cell stack 224 can be equated.

Although specific examples of the disclosure have been described in detail above, the examples are merely examples and do not limit the scope of claims. The technique described in the claims includes various modifications and variations of the specific examples exemplified above.

### First Modification

In the first and second embodiments, each of the discharge pipes 16, 22 may 22 may have the same configuration as the discharge pipes 116, 222 of the third embodiment. In this case, the control device 24 controls the operations of the flow regulating valves 44, 64, 144, and 164 in S16 of the valve control process in FIG. 2.

### Second Modification

In the first and second embodiments, the positions P2 and P5 may be located above the lower ends of the cases 30 and 50. The positions P2 and P5 may be located on the lower end side of the central position of the cases 30 and 50 in the stacking direction. The same applies to the positions P13, P16, etc. of the third embodiment.

In addition, the technical elements described in this specification or in the drawings exhibit technical usefulness alone or in various combinations, and are not limited to the combinations described in the claims at the time of filing. In addition, the technique exemplified in the present specification or drawings can achieve a plurality of purposes at the same time, and achieving one of the purposes itself has technical usefulness.

What is claimed is:

1. A fuel cell unit comprising:
an air compressor;
a first fuel cell stack;
a second fuel cell stack;
a first supply pipe that supplies air from the air compressor to the first fuel cell stack;
a first discharge pipe that recovers post-reaction air discharged from the first fuel cell stack;
a second supply pipe that supplies air from the air compressor to the second fuel cell stack; and
a second discharge pipe that recovers post-reaction air discharged from the second fuel cell stack, wherein:
the first supply pipe includes a first main pipe connected to a first position of the first fuel cell stack and a first bypass pipe connected to a second position of the first fuel cell stack;
the second supply pipe includes a second main pipe connected to a third position of the second fuel cell stack and a second bypass pipe connected to a fourth position of the second fuel cell stack; and
a flow regulating valve is provided in each of the first bypass pipe and the second bypass pipe.

2. The fuel cell unit according to claim 1, wherein:
each of the first fuel cell stack and the second fuel cell stack includes an air supply manifold through which pre-reaction air flows along a stacking direction of fuel-cell cells;
the first position is located at, in the stacking direction, one end of the air supply manifold of the first fuel cell stack;
the second position is located at, in the stacking direction, another end of the air supply manifold of the first fuel cell stack;
the third position is located at, in the stacking direction, one end of the air supply manifold of the second fuel cell stack; and
the fourth position is located at, in the stacking direction, another end of the air supply manifold of the second fuel cell stack.

3. The fuel cell unit according to claim 1, further comprising a control device that controls the flow regulating valve, wherein the control device controls the flow regulating valve such that “air supply amount per cell” is equal between the first fuel cell stack and the second fuel cell stack.

4. The fuel cell unit according to claim 1, further comprising a control device that controls the flow regulating valve, wherein the control device controls the flow regulating valve such that an “air supply pressure” is equal between the first fuel cell stack and the second fuel cell stack.

5. A fuel cell unit comprising:
an air compressor;
a first fuel cell stack;
a second fuel cell stack;
a first supply pipe that supplies air from the air compressor to the first fuel cell stack;
a first discharge pipe that recovers post-reaction air discharged from the first fuel cell stack;
a second supply pipe that supplies air from the air compressor to the second fuel cell stack; and
a second discharge pipe that recovers post-reaction air discharged from the second fuel cell stack, wherein:
the first discharge pipe includes a first main pipe connected to a fifth position of the first fuel cell stack and a first bypass pipe connected to a sixth position of the first fuel cell stack;
the second discharge pipe includes a second main pipe connected to a seventh position of the second fuel cell stack and a second bypass pipe connected to an eighth position of the second fuel cell stack; and
a flow regulating valve is provided in each of the first bypass pipe and the second bypass pipe.

6. The fuel cell unit according to claim 5, further comprising a control device that controls the flow regulating valve, wherein the control device controls the flow regulating valve such that “air supply amount per cell” is equal between the first fuel cell stack and the second fuel cell stack.

7. The fuel cell unit according to claim 5, further comprising a control device that controls the flow regulating valve, wherein the control device controls the flow regulating valve such that an “air supply pressure” is equal between the first fuel cell stack and the second fuel cell stack.
